(19) United States
(12) Patent Application Publication
(10) Pub. No.: US 2004/0206239 A1
(43) Pub. Date: Oct. 21, 2004

(54) Method for reducing gaseous contamination in a pressure vessel

(76) Inventors: Daniel B. Laubacher, Wilmington, DE (US); James D. McCambridge, Swathmore, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/782,555

(22) Filed: Feb. 19, 2004

Related U.S. Application Data
(60) Provisional application No. 60/448,850, filed on Feb. 20, 2003.

(51) Int. Cl. B01D 53/02

(52) U.S. Cl. 96/108

(57) ABSTRACT

This invention relates to a method for reducing gaseous contamination in a pressure vessel that comprises using a getter as an integral part of the pressure vessel and thereby eliminating the need for a bakeout cycle.

This application claims the benefit of U.S. Provisional Application No. 60/448,850, filed on Feb. 20, 2003, which is incorporated in its entirety as a part hereof for all purposes.

### FIELD OF THE INVENTION

This invention relates to a method for reducing gaseous contamination in a pressure vessel that comprises using a getter as an integral part of the pressure vessel.

### BACKGROUND OF THE INVENTION

There are a number of instances in which a pressure vessel is filled with a particular gas and for proper operation it is important that the gas not be contaminated with other gases.

One such pressure vessel is a cryocooler. A cryocooler is a refrigerator that is used for generating extremely low temperatures, i.e., typically of the order of 150K or lower. Cryocoolers are used in various industrial, medical, research and military applications. The discovery and use of high temperature superconductor (HTS) materials that superconduct at temperatures of 77K or higher have increased the need for cryocoolers.

Cryocoolers are operated on a thermodynamic cycle involving the compression and expansion of a working gas. Several such cycles are used in cryocooler technology, e.g., Gifford-McMahon, Brayton and Stirling. For example, Stirling cycle based cryocoolers or Stirling coolers are comprised of a working gas, a piston for the isothermal compression of the working gas, a regenerator and a displacer. The displacer moves the compressed gas at constant volume from the warmer section of the cryocooler where it was compressed through the regenerator into the colder section of the cryocooler where the gas undergoes an isothermal expansion. Following the expansion, the displacer then moves the gas at constant volume through the regenerator to be compressed again by the piston. The regenerator is cooled by the cool gas passing through it and so can cool the compressed gas in subsequent cycles as it is moved through the regenerator to the expansion chamber. The use of the regenerator improves the efficiency of the cryocooler.

It is important that the working gas remains as a gas during the operation of the cryocooler. This requires that the gas used as the working gas have a transition temperature to the liquid state that is below the cooling temperature. For this reason, helium, which liquefies at about 4K, is the usual choice for the working gas for cryocoolers with cooling temperatures above 4K. Other gases that would liquefy at operating temperatures are to be avoided. Desorption of such other gases as may be adsorbed on the inner surface of the cryocooler pressure vessel, i.e., outgassing, is therefore important. Typical outgassing practice is to subject the cryocooler pressure vessel to a bakeout step, i.e., maintaining the cryocooler pressure vessel at a high temperature while under a high vacuum, i.e., 10⁻⁶-10⁻⁷ mbar, before filling the cryocooler pressure vessel with the working gas, such as high purity helium.

The materials used in the construction of the cryocooler pressure vessel and the temperature to which they can be subjected must be considered when deciding on the temperature used for this bakeout. At lower temperatures, longer bakeout times are needed to provide the necessary outgassing and bakeout times on the order of days are typical. Therefore, this procedure can add considerable time and cost to the production of the cryocooler. In addition, it requires the purchase and maintenance of a high vacuum system dedicated to the bakeout cycle and of equipment needed to bakeout the cryocooler pressure vessel and a source of high purity working gas.

An object of the present invention is to provide an improved method for more efficiently reducing gaseous contamination in pressure vessels and, in particular, in cryocooler pressure vessels.

### SUMMARY OF THE INVENTION

This invention relates to a method for reducing gaseous contamination in a pressure vessel, i.e., any vessel that is to be pressurized with a gas and for which the absence of gaseous contaminants is important. A gas of choice is used to pressurize the pressure vessel. The method comprises (a) providing a getter as an integral part of the pressure vessel; (b) evacuating the pressure vessel; (c) activating the getter; (d) filling the pressure vessel with the gas of choice; and (e) sealing the pressure vessel, wherein the getter has sufficient sorption capacity to adsorb gaseous contaminants and has negligible sorption capacity for the gas of choice.

The getter can be within the pressure vessel or within an appendage attached to the pressure vessel. The getter can contain an internal resistor with lead wires so that the getter can be activated by electrical heating by an electrical current provided by an external source, or it can be heated by an external heater. Preferably the getter is in the form of an appendage getter pump that is attached to and made a part of the pressure vessel and is activated by heating with an external heater.

In particular, this invention relates to a method for reducing gaseous contamination in a cryocooler pressure vessel that comprises the use of a getter as an integral part of the cryocooler pressure vessel. The method comprises (a) providing a getter as an integral part of the cryocooler pressure vessel; (b) evacuating the cryocooler pressure vessel; (c) activating the getter; (d) filling the cryocooler pressure vessel with a working gas; and (e) sealing the cryocooler pressure vessel, wherein the getter has sufficient sorption capacity to adsorb gaseous contaminants and has negligible sorption capacity for the working gas.

Preferably, the working gas is helium. The getter can be within the cryocooler pressure vessel or within an appendage attached to the cryocooler pressure vessel. The getter can contain an internal resistor with lead wires so that the getter can be activated by electrical heating by an electrical current provided by an external source, or it can be heated by an external heater. Preferably the getter is in the form of an appendage getter pump that is attached to and made a part of the cryocooler pressure vessel and is activated by heating with an external heater.

Yet another embodiment of this invention is a method for reducing remaining gaseous contamination in a pressure vessel containing a gas of choice, said pressure vessel having undergone an incomplete outgassing bakeout step, by providing a getter as an integral part of said pressure vessel, wherein said getter has sufficient sorption capacity to adsorb remaining gaseous contaminants and has negligible sorption capacity for said gas of choice.

Yet another embodiment of this invention is a pressure vessel containing a gas of choice, that includes, as an integral part of said pressure vessel, a getter that (a) has sufficient sorption capacity to adsorb gaseous contaminants without the necessity of an outgassing bakeout step and (b) has negligible sorption capacity for said gas of choice.

Yet another embodiment of this invention is a pressure vessel containing a working gas that includes, as an integral part of the pressure vessel, a getter that (a) has negligible sorption capacity for the working gas, and (b) has sufficient sorption capacity to remove all or substantially all gaseous contamination from the working gas at the temperature and pressure at which the pressure vessel is operated.

Yet another embodiment of this invention is a method for reducing gaseous contamination in a pressure vessel containing a working gas by (a) determining an amount of contaminant in the working gas; and (b) providing, as an integral part of the pressure vessel, a getter that (i) has negligible sorption capacity for the working gas, and (ii) has sufficient sorption capacity to remove from the working gas, at the temperature and pressure at which the pressure vessel is operated, the amount of gaseous contamination determined in step (a). This embodiment typically further involves (c) evacuating the pressure vessel; (d) activating the getter; (e) filling the pressure vessel with the working gas; and (f) sealing the pressure vessel.

### BRIEF DESCRIPTION OF THE DRAWING

FIG. 1 shows a block diagram of the instant method for reducing gaseous contamination in a cryocooler pressure vessel.

### DETAILED DESCRIPTION OF THE PREFERRED EMBODIMENT

The present invention provides a method for reducing gaseous contamination in a pressure vessel by providing a getter as an integral part of the pressure vessel. The getter must be chosen appropriately to have sufficient sorption capacity to adsorb the gaseous contaminants and to have negligible sorption capacity for the working gas. The gaseous contaminants referred to herein are unwanted gases that are adsorbed on the inner surface area of the pressure vessel and on the surfaces of its contents and are subject to outgassing, as well as to unwanted impurity gases that are introduced with the gas of choice with which the pressure vessel is filled. The gaseous contamination referred to herein is the presence of gaseous contaminants. No bakeout is necessary with the instant method.

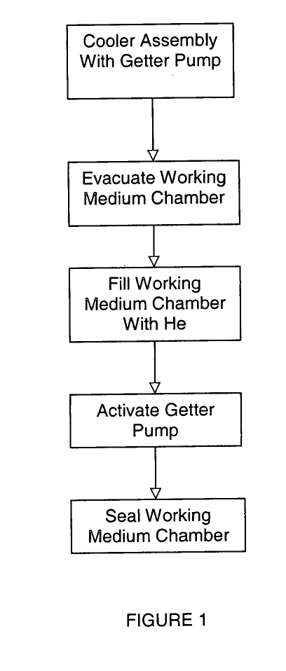

The gas of choice may not only be a working gas that is subjected to physical manipulation in the pressure vessel, but may also be a static gas that serves, for example, as an inert medium. A cryocooler pressure vessel containing a getter as an integral part of the cryocooler pressure vessel and using helium as the working gas will be used to illustrate the method of the invention without limiting the method to that particular type of pressure vessel or working gas. The cryocooler pressure vessel is evacuated for only a brief time to pressures of only 10⁻²-10⁻³ mbar during which time the getter is activated. When the activation step is completed, helium is introduced into the cryocooler pressure vessel and the cryocooler pressure vessel is sealed. A block diagram of the process is shown in FIG. 1.

The getter is an integral part of the cryocooler pressure vessel and, as indicated above, must be chosen appropriately to have sufficient sorption capacity to adsorb the gaseous contaminants and to have negligible sorption capacity for helium.

The amount of gaseous contaminants to be removed as a result of outgassing can be estimated based on the inner surface area of the cryocooler pressure vessel and the surface area of its contents and the particular materials used in the construction of the cryocooler pressure vessel and its contents. Typically the volume of adsorbed gases is equivalent to a few monolayers coverage of the surface. Allowance must be made for the varying degree to which the different components or materials used tend to outgas. Estimates of the amount of gaseous contaminants introduced as impurity gases with the helium can be obtained from the supplier of the helium. A getter is then chosen with a sorption capacity of several times, for example at least 3-5 times, that estimated to be needed in order to provide a safe margin of design. This getter can then be tested in the cryocooler pressure vessel to determine if the estimate was correct and performance is as expected. If not, a getter with even greater sorption capacity, for example at least an additional 2-3 times more sorption capacity, can be used and tested. When the expected performance has been obtained, such a getter can be used in all similar cryocooler pressure vessels produced. The use of a getter with a high sorption capacity will enable relaxation of restrictions with regard to outgassing placed on materials chosen for the cryocooler pressure vessel construction and its contents.

Getters generally are activated by heating to remove any oxide or nitride coatings. This activation is carried out before the cryocooler pressure vessel has been filled with helium and sealed. When the getter is contained within the cryocooler pressure vessel, this heating can be accomplished by passing an electrical current through internal heaters, which are located inside the pressure vessel. An alternate way to provide for a getter is to have the getter contained in one or more appendages that are an integral part of the cryocooler pressure vessel. The getter can be heated by passing an electrical current through internal heaters as described previously. Preferably, the appendage is heated to a temperature sufficient to activate the getter contained in the appendage by means of an external heater outside the pressure vessel designed to fit around or encompass the appendage. The appendage can be in the form of a hollow cylinder or any other convenient shape and is typically welded to the cryocooler pressure vessel. Care must be taken to avoid overheating the sensitive components of the cryocooler pressure vessel during activation. Particularly when the getter is contained in an appendage, the getter can be placed sufficiently far from or shielded from the cryocooler pressure vessel contents to protect the contents from a harmfully high temperature when the getter is activated. Careful design and the use of a getter located in an appendage can therefore result in a significant reduction in the maximum temperature experienced by the contents compared to that occurring during a typical outgassing bakeout step.

If a shortened incomplete outgassing bakeout step is used and a significant amount of gas is still adsorbed on the inner surface of the cryocooler pressure vessel and the surfaces of its contents, the instant invention provides a method for reducing the remaining gaseous contamination, i.e., the remaining unwanted gases adsorbed on the inner surface of the cryocooler pressure vessel and the surfaces of its contents and unwanted impurity gases introduced with the working gas. In this instance, the getter must be chosen appropriately to have sufficient sorption capacity to adsorb these remaining gaseous contaminants.

Typical getters which can be placed within the cryocooler pressure vessel or within appendages are Zr—V—Fe alloys such as the getter St 707™ available from SAES Getters, S.p.A., Milan, Italy. Preferably, the getter is in the form of an appendage getter pump available from SAES Getters USA Inc., Colorado Springs, Colo. 80906. The appendage getter pump can be bolted to the cryocooler pressure vessel using holes in the flange provided by the vendor or it can be welded to the cryocooler pressure vessel.

The method of the invention for reducing gaseous contamination in a cryocooler pressure vessel requires considerably less time than the method currently used and eliminates the need for a bakeout cycle and the time it consumes, the need for an expensive high vacuum system dedicated to the bakeout cycle and equipment to bakeout the cryocooler and the need for a source of high purity helium. Similar advantages accrue when applying the instant method for reducing gaseous contamination to other types of pressure vessels that may contain other gases.

What is claimed is:

1. A method for reducing gaseous contamination in a pressure vessel, comprising:
(a) providing a getter as an integral part of said pressure vessel;
(b) evacuating said pressure vessel;
(c) activating said getter;
(d) filling said pressure vessel with a gas of choice; and
(e) sealing said pressure vessel, wherein said getter has sufficient sorption capacity to adsorb gaseous contaminants and has negligible sorption capacity for said gas of choice.

2. The method of claim 1, wherein said pressure vessel is a cryocooler and said gas of choice is a working gas.

3. The method of claim 2, wherein said working gas is helium.

4. The method of claim 1 or 2, wherein said getter is activated by passing an electrical current through an internal heater.

5. The method of claim 1 or 2, wherein said getter is contained in an appendage that is an integral part of said pressure vessel.

6. The method of claim 5, wherein said getter is activated by heating with an external heater.

7. The method of claim 1 or 2, wherein said getter is in the form of an appendage getter pump that is an integral part of said pressure vessel.

8. The method of claim 7, wherein said getter is activated by heating with an external heater.

9. The method of claim 1 or 2, wherein said getter is a zirconium alloy.

10. A method for reducing gaseous contamination in a pressure vessel containing a gas of choice, comprising providing a getter as an integral part of said pressure vessel, wherein said getter has sufficient sorption capacity to adsorb gaseous contaminants and thereby eliminates the need for a bakeout cycle and wherein said getter has negligible sorption capacity for said gas of choice.

11. The method of claim 10, wherein said pressure vessel is a cryocooler and said gas of choice is a working gas.

12. The method of claim 11, wherein said working gas is helium.

13. The method of claim 10 or 11, wherein said getter is activated by passing an electrical current through an internal heater.

14. The method of claim 10 or 11, wherein said getter is contained in an appendage that is an integral part of said pressure vessel.

15. The method of claim 14, wherein said getter is activated by heating with an external heater.

16. The method of claim 10 or 11, wherein said getter is in the form of an appendage getter pump that is an integral part of said pressure vessel.

17. The method of claim 16, wherein said getter is activated by heating with an external heater.

18. The method of claim 10 or 11, wherein said getter is a zirconium alloy.

19. A method for reducing remaining gaseous contamination in a pressure vessel containing a gas of choice, said pressure vessel having undergone an incomplete outgassing bakeout step, comprising providing a getter as an integral part of said pressure vessel, wherein said getter has sufficient sorption capacity to adsorb remaining gaseous contaminants and has negligible sorption capacity for said gas of choice.

20. The method of claim 19, wherein said pressure vessel is a cryocooler and said gas of choice is a working gas.

21. The method of claim 20, wherein said working gas is helium.

22. The method of claim 19 or 20, wherein said getter is activated by passing an electrical current through an internal heater.

23. The method of claim 19 or 20, wherein said getter is contained in an appendage that is an integral part of said pressure vessel.

24. The method of claim 23, wherein said getter is activated by heating with an external heater.

25. The method of claim 19 or 20, wherein said getter is in the form of an appendage getter pump that is an integral part of said pressure vessel.

26. The method of claim 25, wherein said getter is activated by heating with an external heater.

27. The method of claim 19 or 20, wherein said getter is a zirconium alloy.

28. A pressure vessel containing a gas of choice, comprising, as an integral part of said pressure vessel, a getter that (a) has sufficient sorption capacity to adsorb gaseous contaminants without the necessity of an outgassing bakeout step and (b) has negligible sorption capacity for said gas of choice.

29. The pressure vessel of claim 28, wherein said pressure vessel is a cryocooler and said gas of choice is a working gas.

30. The pressure vessel of claim 29, wherein said working gas is helium.

31. The pressure vessel of claim 28 or 29, wherein said getter is contained in an appendage that is an integral part of said pressure vessel.

32. The pressure vessel of claim 28 or 29, wherein said getter is in the form of a appendage getter pump that is an integral part of said pressure vessel.

33. The pressure vessel of claim 28, wherein said getter is a zirconium alloy.

34. The cryocooler pressure vessel of claim 31, wherein said getter is a zirconium alloy.

35. The cryocooler pressure vessel of claim 32, wherein said getter is a zirconium alloy.
